(19) United States
(12) Patent Application Publication
(10) Pub. No.: US 2025/0325074 A1
(43) Pub. Date: Oct. 23, 2025

(54) COVER MEMBER AND LINEAR MOTION GUIDE UNIT

(71) Applicants: YKK CORPORATION, Tokyo (JP); NIPPON THOMPSON CO., LTD., Tokyo (JP)

(72) Inventors: Hideaki TAKENAKA, Tokyo (JP); Tomoaki NAKAMURA, Mino-shi (JP); Takafumi KAWASHIMA, Mino-shi (JP)

(73) Assignees: YKK CORPORATION, Tokyo (JP); NIPPON THOMPSON CO., LTD., Tokyo (JP)

(21) Appl. No.: 18/869,994

(22) PCT Filed: May 11, 2023
(86) PCT No.: PCT/JP2023/017754

§ 371 Date: Nov. 27, 2024

(30) Foreign Application Priority Data
Jun. 17, 2022 (JP) 2022-097976

(51) Int. Cl. A44B 19/24; F16C 29/06; F16C 29/08

(52) U.S. Cl. CPC A44B 19/24; F16C 29/08; F16C 29/06

(57) ABSTRACT

A cover member includes a longitudinally extending fastener and covers a mechanical element component, including a wall having the fastener arranged thereon and forming a space for accommodating the mechanical element component. The fastener includes a right side element extending along the longitudinal direction, a left side element extending in the longitudinal direction along and engageable with the right, a front slider attached to the elements, and a rear slider attached to the elements and spaced apart from the front slider. During movement of the front and rear sliders, the sliders each disengage the elements from each other while moving in a direction opposite to a side where the other slider is located, and engage the elements with each other while the slider moves in a direction toward the side where the other slider is located. The wall has a hook and loop fastener provided thereon.

### TECHNICAL FIELD

The present disclosure relates to a cover member and a linear motion guide unit. The present application claims priority based on Japanese Patent Application No. 2022-97976 filed on Jun. 17, 2022, the entire contents of which are incorporated herein by reference.

### BACKGROUND ART

A guide apparatus having a dustproof structure in which a portion of a movable body projects outwardly through an opening formed in an outer cover and the movable body moves along the opening is known (see, for example, Patent Literature 1). According to the dustproof guide apparatus disclosed in Patent Literature 1, a plurality of flexible belt-shaped seal members are attached to edge portions of the opening, and the seal members have their end portions overlapping each other.

### CITATION LIST

### Patent Literature

Patent Literature 1: Japanese Patent Application Laid-Open No. 2000-230618

### SUMMARY OF INVENTION

### Technical Problem

In order to improve dustproof and waterproof properties, a cover member may be provided for mechanical element components included in a linear motion guide unit, such as a rail and a sliding member, to thereby avoid exposure of the rail and the sliding member as much as possible. Such a cover member, used for improving the sealing of the mechanical element components, is attached to a predetermined location for use. It is desired for the cover member to improve the ease of attachment while ensuring a high level of sealing.

Thus, one of the objects is to provide a cover member capable of improving ease of attachment while ensuring a high level of sealing.

### Solution to Problem

A cover member according to the present disclosure includes a longitudinally extending fastener and covers a mechanical element component. The cover member includes a wall having the fastener arranged thereon and forming a space for accommodating the mechanical element component. The fastener includes a right side element extending along the longitudinal direction, a left side element extending in the longitudinal direction along the right side element and engageable with the right side element, a front slider attached to the right side element and the left side element, and a rear slider attached to the right side element and the left side element and spaced apart from the front slider in the longitudinal direction. During movement of the front slider and the rear slider in the longitudinal direction, the front slider and the rear slider each disengage the right side element and the left side element from each other while the slider moves in a direction opposite to a side where the other slider is located, and engage the right side element and the left side element with each other while the slider moves in a direction toward the side where the other slider is located. The wall has a hook and loop fastener provided thereon.

### Advantageous Effects of Invention

The cover member described above is capable of improving the ease of attachment while ensuring a high level of sealing.

### BRIEF DESCRIPTION OF DRAWINGS

FIG. 1 is a schematic perspective view of a linear motion guide unit including a cover member in Embodiment 1 of the present disclosure.

FIG. 2 is a schematic plan view of the linear motion guide unit shown in FIG. 1.

FIG. 3 is a schematic bottom view of the linear motion guide unit shown in FIG. 1.

FIG. 4 is a schematic front view of the linear motion guide unit shown in FIG. 1.

FIG. 5 is a schematic cross-sectional view when cut in a cross section indicated by V-V in FIG. 1.

FIG. 6 is a schematic perspective view of the linear motion guide unit shown in FIG. 1, with the illustration of the cover member, described later, partially omitted.

FIG. 7 is a schematic front view of the linear motion guide unit shown in FIG. 6.

FIG. 8 is a schematic perspective view of the linear motion guide unit shown in FIG. 1, with the illustration of a moving member, described later, omitted.

FIG. 9 is a schematic perspective view of the linear motion guide unit shown in FIG. 1, with the illustration of the moving member and a part of the cover member omitted.

FIG. 10 is a schematic perspective view of a linear motion guide unit in Embodiment 2 of the present disclosure.

FIG. 11 is a schematic perspective view of a portion of a linear motion guide unit in Embodiment 3 of the present disclosure.

FIG. 12 is a schematic perspective view of a portion of a linear motion guide unit in Embodiment 4 of the present disclosure.

FIG. 13 is a schematic perspective view of a portion of the linear motion guide unit in Embodiment 4 of the present disclosure.

FIG. 14 is a schematic plan view of the linear motion guide unit shown in FIG. 12.

FIG. 15 is a schematic bottom view of the linear motion guide unit shown in FIG. 12.

FIG. 16 is a schematic front view of the linear motion guide unit shown in FIG. 12.

FIG. 17 is a schematic cross-sectional view when cut in a cross section indicated by XVII-XVII in FIG. 2.

FIG. 18 is a schematic perspective view of the linear motion guide unit shown in FIG. 12, with the illustration of a cover member partially omitted.

FIG. 19 is a schematic perspective view of the linear motion guide unit shown in FIG. 12, with the illustration of a moving member omitted.

FIG. 20 is a schematic perspective view of the linear motion guide unit shown in FIG. 12, with the illustration of the moving member and a part of the cover member omitted.

FIG. 21 is a schematic perspective view of a linear motion guide unit in Embodiment 5 of the present disclosure.

FIG. 22 is a schematic cross-sectional view when cut in a cross section indicated by XXII-XXII in FIG. 21.

### DESCRIPTION OF EMBODIMENTS

### Outline of Embodiments

A cover member of the present disclosure includes a longitudinally extending fastener and covers a mechanical element component. The cover member includes a wall having the fastener arranged thereon and forming a space for accommodating the mechanical element component. The fastener includes a right side element extending along the longitudinal direction, a left side element extending in the longitudinal direction along the right side element and engageable with the right side element, a front slider attached to the right side element and the left side element, and a rear slider attached to the right side element and the left side element and spaced apart from the front slider in the longitudinal direction. During movement of the front slider and the rear slider in the longitudinal direction, the front slider and the rear slider each disengage the right side element and the left side element from each other while the slider moves in a direction opposite to a side where the other slider is located, and engage the right side element and the left side element with each other while the slider moves in a direction toward the side where the other slider is located. The wall has a hook and loop fastener provided thereon.

The cover member of the present disclosure can properly cover the mechanical element component by accommodating the mechanical element component in the space formed by the wall. The wall includes the fastener of the above-described configuration, allowing the fastener to be opened and closed while maintaining a high level of sealing. The wall has the hook and loop fastener provided thereon, which eliminates the need for screws, adhesives, or the like for attaching the cover member, and facilitates positioning. Since the fastening is done on a surface using the hook and loop fastener, a gap is unlikely to occur, and a high level of sealing can be maintained in the space that houses the mechanical element component. Accordingly, such a cover member is capable of improving the ease of attachment while ensuring a high level of sealing. Here, a fastener refers to one having a plurality of teeth (fastener teeth) attached along a longitudinal direction on both sides in a width direction (direction perpendicular to the longitudinal direction) of a cut portion (opening region) extending in the longitudinal direction.

A linear motion guide unit of the present disclosure includes: a rail including a rail upper surface and a rail side surface each extending in a longitudinal direction and having a first raceway surface provided on the rail side surface; a sliding member relatively movably attached to the rail and including a sliding member lower surface facing the rail upper surface and a second raceway surface facing the first raceway surface; a plurality of rolling elements rolling on a load-carrying race constituted by the first and second raceway surfaces; a cover member covering the rail and the sliding member and including a fastener extending in the longitudinal direction; a moving member arranged outside the cover member and moving together with the sliding member; and a connecting member connecting the sliding member to the moving member. The cover member includes a wall having the fastener arranged thereon and forming a space for accommodating the rail and the sliding member. The fastener includes a right side element extending along the longitudinal direction, a left side element extending in the longitudinal direction along the right side element and engageable with the right side element, a front slider attached to the right side element and the left side element and fixed to the sliding member and the moving member, and a rear slider attached to the right side element and the left side element, spaced apart from the front slider in the longitudinal direction, and fixed to the sliding member and the moving member. During movement of the sliding member and the moving member, the front slider and the rear slider each disengage the right side element and the left side element from each other while the slider moves in a direction opposite to a side where the other slider is located, and engage the right side element and the left side element with each other while the slider moves in a direction toward the side where the other slider is located. The connecting member includes a support member arranged between the front slider and the rear slider in the longitudinal direction and supporting the moving member. The wall has a hook and loop fastener provided thereon.

According to the linear motion guide unit of the present disclosure, the cover member covers the rail and the sliding member by accommodating the rail and the sliding member in the space formed by the wall. During operation of the sliding member, i.e., during a linear reciprocating motion of the sliding member, the disengagement and engagement between the right side element and the left side element included in the fastener allow the sliding member to slide while maintaining the state where the rail and the sliding member are covered by the cover member. Thus, it is possible to improve the dustproof and waterproof properties during the sliding of the sliding member. The wall has the hook and loop fastener provided thereon, which eliminates the need for screws, adhesives, or the like for attaching the cover member, and facilitates positioning. Since the fastening is done on a surface using the hook and loop fastener, a gap is unlikely to occur, and a high level of sealing can be maintained in the space that houses the rail and the sliding member. Accordingly, such a linear motion guide unit is capable of improving the ease of attachment while ensuring a high level of sealing of the cover member.

In the linear motion guide unit described above, the wall may include a flat plate portion. The hook and loop fastener may be arranged on one side in a thickness direction of the flat plate portion. With this, at the time of attaching the cover member, the flat plate portion included in the wall can be utilized to properly attach the hook and loop fastener to an installation location. This can further improve the ease of attachment.

In the linear motion guide unit described above, the wall may have an opening communicating with the space. The hook and loop fastener may be arranged to surround the opening. This can further improve the sealing in the cover member. Accordingly, a high level of sealing can be more reliably maintained.

In the linear motion guide unit described above, the wall may include an upper wall portion on which the fastener is arranged, and a side wall portion that extends intersecting the upper wall portion. The hook and loop fastener is attached to the side wall portion. This can reduce the risk of foreign matter such as dust being deposited on a portion where the hook and loop fastener is arranged. Thus, the risk of the foreign matter entering the cover member can be reduced, and the smooth operation of the sliding member can be more reliably ensured.

In the linear motion guide unit described above, at least a portion of the cover member may include a structure made of a plurality of resin materials of different strengths stacked. Adopting such a configuration makes it possible to maintain high strength while ensuring appropriate flexibility in at least a portion of the cover member. Thus, the risk of interference with the sliding member can be reduced while suppressing collapse of the shape in at least a portion of the cover member.

In the linear motion guide unit described above, at least a portion of the cover member may make an inside visible from an outside. This makes it easier to check the condition of the inside of the cover member, and improves maintainability.

In the linear motion guide unit described above, at least one of the front slider and the rear slider may have a seal member operative to sweep an upper portion of a region in which the right side element and the left side element are engaged. With this, the seal member can reduce the risk of foreign matter deposited on top of the cover member entering the inside of the cover member. Thus, the risk of foreign matter entering the load-carrying race can be reduced, and the smooth operation of the sliding member can be more reliably ensured.

In the linear motion guide unit described above, the wall may include an upper wall portion on which the fastener is arranged, and a side wall portion that extends intersecting the upper wall portion. A portion where the upper wall portion and the side wall portion are connected may be configured with a curved surface. This makes it easier for the cover member itself to be deformed, thereby reducing the risk of the cover member sagging or bulging in the state where the fastener is open. Thus, the risk of interference between the sliding member and the cover member can be reduced, and the smooth operation of the sliding member can be more reliably ensured.

In the linear motion guide unit described above, at least one of the right side element and the left side element may include an oil-containing resin provided at a portion where the elements are engaged with each other. With this, smooth movement of the right side element and the left side element can be promoted, and the smooth operation of the sliding member can be ensured.

### Specific Embodiments

Specific embodiments of the linear motion guide unit of the present disclosure will be described below with reference to the drawings. In the drawings referenced below, the same or corresponding portions are denoted by the same reference numerals and the description thereof will not be repeated.

### Embodiment 1

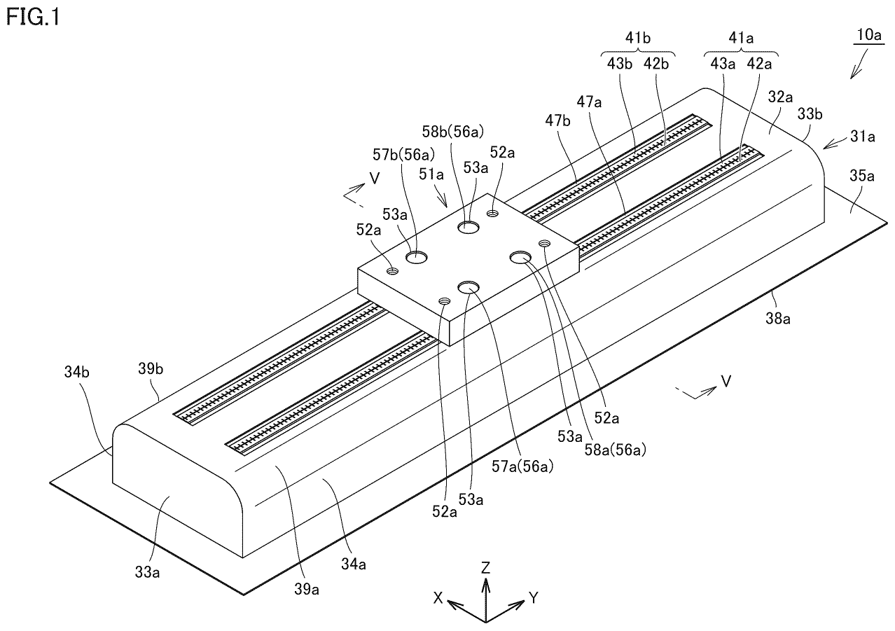

An embodiment of the present disclosure, Embodiment 1, will first be described. FIG. 1 is a schematic perspective view of a linear motion guide unit including a cover member in Embodiment 1 of the present disclosure. In FIG. 1 and the following figures, the X direction indicates a lateral direction, which is the width direction of the linear motion guide unit, the Y direction indicates the longitudinal direction of the linear motion guide unit, and the Z direction indicates the thickness direction (height direction) of the linear motion guide unit. The X, Y, and Z directions are orthogonal to each other. For the sake of convenience in explanation, the direction indicated by the arrow X is regarded as leftward, the direction opposite to that indicated by the arrow X is regarded as rightward, the direction indicated by the arrow Y is regarded as frontward, the direction opposite to that indicated by the arrow Y is regarded as backward, the direction indicated by the arrow Z is regarded as upward, and the direction opposite to that indicated by the arrow Z is regarded as downward. However, these are only for when the linear motion guide unit is arranged as shown in FIG. 1 and others, and the directions of left and right, up and down, or front and back may change depending on, for example, the mounting situation of the linear motion guide unit.

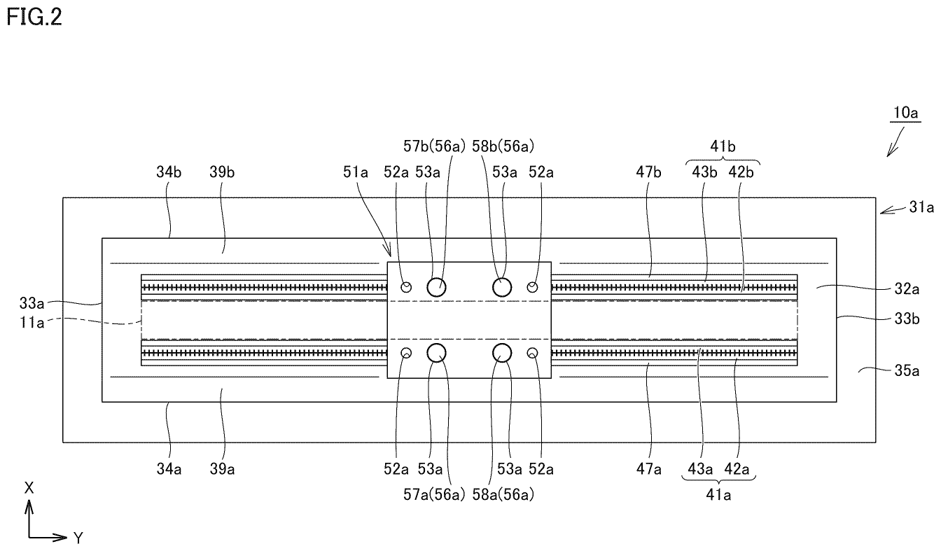

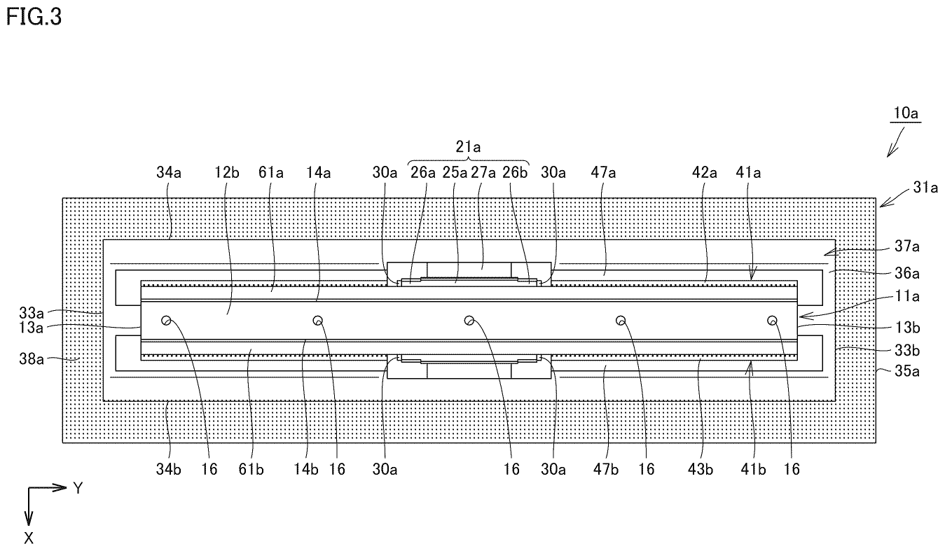

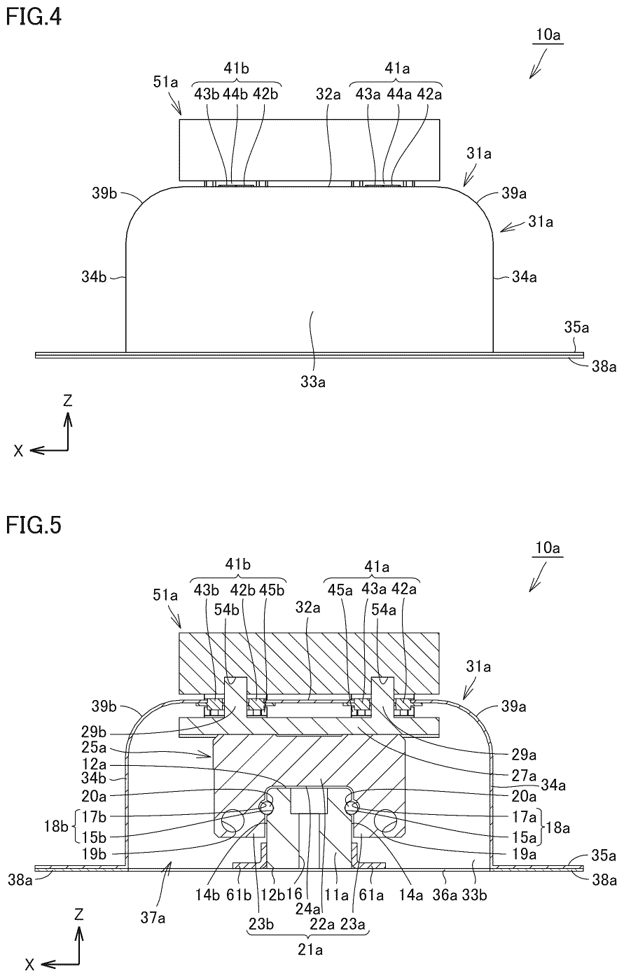

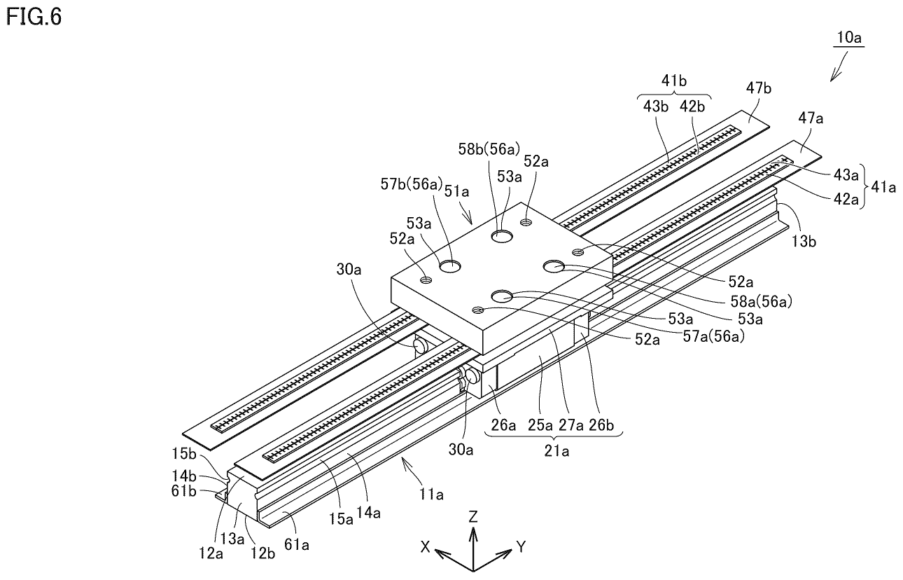

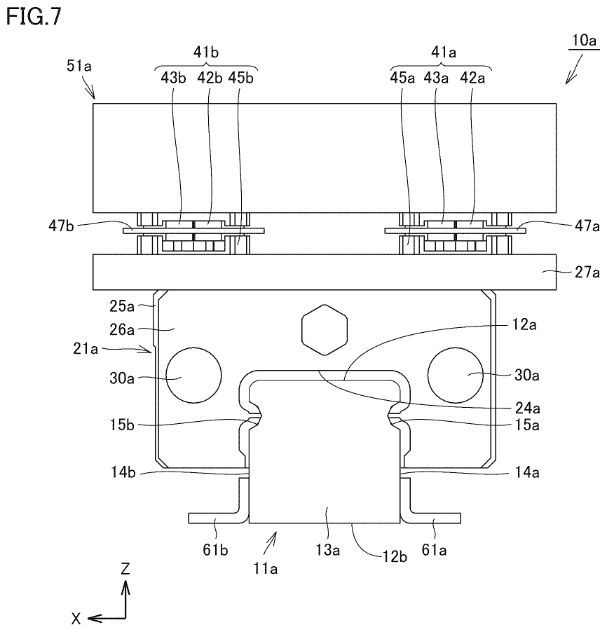

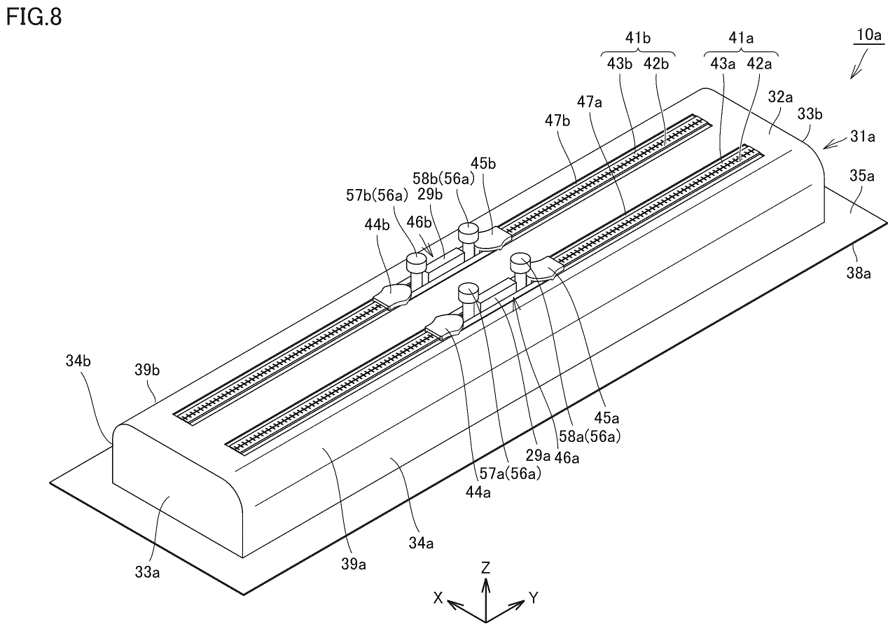

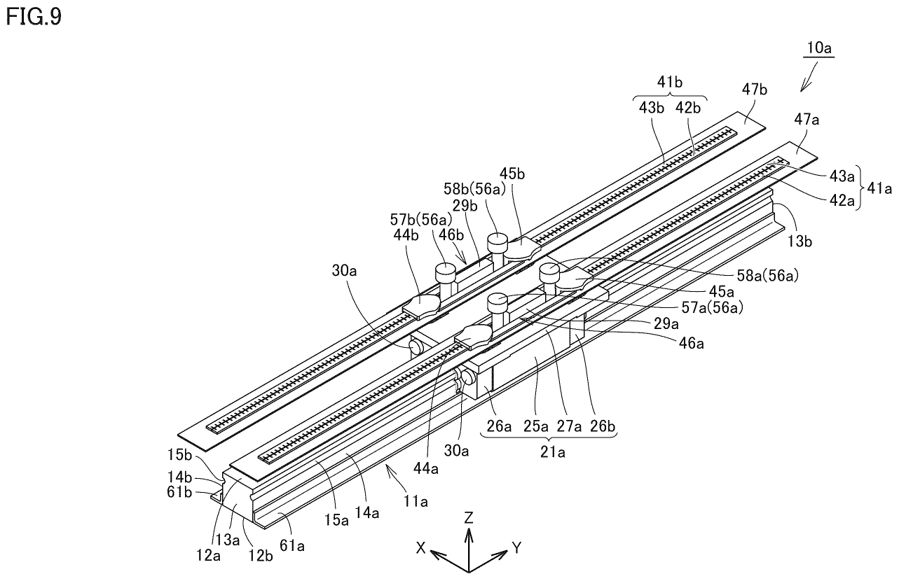

FIG. 2 is a schematic plan view of the linear motion guide unit shown in FIG. 1. FIG. 2 is a view of the linear motion guide unit of FIG. 1 in the direction opposite to the direction indicated by the arrow Z. In FIG. 2, the rail is indicated by a long dashed short dashed line. FIG. 3 is a schematic bottom view of the linear motion guide unit shown in FIG. 1. FIG. 3 is a view of the linear motion guide unit of FIG. 1 in the direction indicated by the arrow Z. FIG. 4 is a schematic front view of the linear motion guide unit shown in FIG. 1. FIG. 4 is a view of the linear motion guide unit of FIG. 1 in the direction indicated by the arrow Y. FIG. 5 is a schematic cross-sectional view when cut in a cross section indicated by V-V in FIG. 1. FIG. 6 is a schematic perspective view of the linear motion guide unit shown in FIG. 1, with the illustration of a cover member, described later, partially omitted. FIG. 7 is a schematic front view of the linear motion guide unit shown in FIG. 6. FIG. 8 is a schematic perspective view of the linear motion guide unit shown in FIG. 1, with the illustration of a moving member, described later, omitted. FIG. 9 is a schematic perspective view of the linear motion guide unit shown in FIG. 1, with the illustration of the moving member and a part of the cover member omitted.

Referring to FIGS. 1 to 9, the linear motion guide unit 10a according to Embodiment 1 of the present disclosure includes a rail 11a, a sliding member 21a, balls 20a as a plurality of rolling elements, a cover member 31a, a moving member 51a, and connecting members 56a. It should be noted that such a configuration including the balls 20a as the rolling elements can reduce the size of the device configuration. The configuration of each member will now be described in detail.

The rail 11a includes a rail upper surface 12a and a rail lower surface 12b spaced apart from each other in the Z direction, a rail front surface 13a and a rail back surface 13b spaced apart from each other in the Y direction, and rail side surfaces 14a and 14b on both sides of the rail 11a spaced apart from each other in the X direction. The rail side surface 14a is located on the right side of the rail 11a, and the rail side surface 14b is located on the left side of the rail 11a. The rail 11a includes first raceway surfaces 15a and 15b provided on the rail side surfaces 14a and 14b, respectively, and extending parallel to each other along the longitudinal direction. In other words, the first raceway surfaces 15a and 15b are arranged on the rail side surfaces 14a and 14b, respectively. The first raceway surfaces 15a and 15b are each recessed in a groove shape. The first raceway surfaces 15a and 15b are each recessed in a semicircular arc shape as viewed in the Y direction along the outer shape of the balls 20a as the rolling elements.

The rail 11a has a plurality of through holes 16 provided to penetrate in the Z direction from the rail upper surface 12a to the rail lower surface 12b (see in particular FIG. 3). The plurality of through holes 16 are spaced apart from each other in the Y direction. The through holes 16 are effectively utilized, for example, to mount the rail 11a at a predetermined location at the time of use of the linear motion guide unit 10a.

The configuration of the sliding member 21a will now be described. The sliding member 21a is relatively movably attached to the rail 11a. The sliding member 21a includes a pair of sleeve portions 23a and 23b arranged on both sides in the width direction of the rail 11a, and a base portion 22a connected to the respective sleeve portions 23a and 23b. The pair of sleeve portions 23a and 23b are spaced apart from each other in the X direction. The base portion 22a includes a sliding member lower surface 24a that faces the rail upper surface 12a when the sliding member 21a is attached to the rail 11a (see in particular FIG. 5). The sliding member 21a is slidably straddled on the rail 11a. In the present embodiment, the sliding member 21a is attached so as to straddle the rail 11a and is movable in the Y direction.

The sliding member 21a includes a carriage 25a, a front end cap 26a, a rear end cap 26b, and an intermediate member 27a. The carriage 25a has a rectangular outer shape as viewed in the Z direction. The carriage 25a includes second raceway surfaces 17a and 17b facing the first raceway surfaces 15a and 15b, respectively (see in particular FIG. 5). The second raceway surfaces 17a and 17b extend in parallel along the longitudinal direction and are each recessed in a groove shape. The second raceway surfaces 17a and 17b are recessed in a semicircular arc shape as viewed in the Y direction along the outer shape of the balls 20a. The first raceway surface 15a and the second raceway surface 17a constitute a load-carrying race 18a on which the balls 20a roll. The first raceway surface 15b and the second raceway surface 17b constitute a load-carrying race 18b on which the balls 20a roll.

The carriage 25a has return passages 19a and 19b provided parallel to the load-carrying races 18a and 18b, respectively. The return passages 19a and 19b extend in the longitudinal direction (Y direction), and the balls 20a move in the return passages 19a and 19b.

The front end cap 26a is attached with bolts 30a to one side in the longitudinal direction of the carriage 25a, specifically to the rail front surface 13a side of the carriage 25a in the longitudinal direction. The front end cap 26a has turnaround passages (not shown) for changing the direction of the balls 20a. The rear end cap 26b is attached to the other side in the longitudinal direction of the carriage 25a, specifically to the rail back surface 13b side of the carriage 25a in the longitudinal direction, with bolts 30a. The rear end cap 26b has turnaround passages (not shown) for changing the direction of the balls 20a. The turnaround passages connect the load-carrying race 18a to the return passage 19a and the load-carrying race 18b to the return passage 19b. A plurality of balls 20a circulate through the load-carrying race 18a, the turnaround passage provided in the front end cap 26a, the return passage 19a, and the turnaround passage provided in the rear end cap 26b. A plurality of balls 20a circulate through the load-carrying race 18b, the turnaround passage provided in the front end cap 26a, the return passage 19b, and the turnaround passage provided in the rear end cap 26b.

The carriage 25a is provided with a plurality of, specifically four, mounting holes (not shown) spaced apart from each other in the X and Y directions. These mounting holes are utilized by the connecting members 56a to connect the sliding member 21a including the carriage 25a to the moving member 51a.

The intermediate member 27a is plate-shaped, and rectangular as viewed in the Z direction. In the Z direction, the intermediate member 27a is arranged between the carriage 25a, the front end cap 26a, and the rear end cap 26b on the one hand and an upper wall portion 32a, described later, of the cover member 31a on the other hand. The intermediate member 27a is fixed to the carriage 25a. The intermediate member 27a is provided so as to be slidable together with the carriage 25a, the front end cap 26a, and the rear end cap 26b. The intermediate member 27a is provided with a pair of positioning projections 29a and 29b projecting in the thickness direction (Z direction). The pair of positioning projections 29a and 29b are spaced apart from each other in the X direction. The pair of positioning projections 29a and 29b each have a shape extending in the Y direction. These positioning projections 29a and 29b are utilized for positioning the moving member 51a when the intermediate member 27a and the moving member 51a are connected.

The configuration of the cover member 31a covering the rail 11a and the sliding member 21a will now be described. The cover member 31a includes a wall forming a space 37a for accommodating the rail 11a and the sliding member 21a as the mechanical element components. Specifically, the cover member 31a includes an upper wall portion 32a, a front side wall portion 33a, a back side wall portion 33b, a right side wall portion 34a, a left side wall portion 34b, and a flat plate portion 35a. The upper wall portion 32a, the front side wall portion 33a, the back side wall portion 33b, the right side wall portion 34a, and the left side wall portion 34b form the space 37a in which the rail 11a and the sliding member 21a as the mechanical element components are accommodated. The front side wall portion 33a is a side wall portion located on the front side, the back side wall portion 33b is a side wall portion located on the back side, the right side wall portion 34a is a side wall portion located on the right side, and the left side wall portion 34b is a side wall portion located on the left side. The cover member 31a has a rectangular outer shape which is longer in the longitudinal direction (Y direction) than in the lateral direction (X direction) as viewed in the thickness direction (Z direction) of the flat plate portion 35a. The flat plate portion 35a has an opening 36a provided at the center, which communicates with the space 37a. The front side wall portion 33a, the back side wall portion 33b, the right side wall portion 34a, and the left side wall portion 34b are provided so as to rise from the flat plate portion 35a. The front side wall portion 33a, the back side wall portion 33b, the right side wall portion 34a, and the left side wall portion 34b are each connected to the upper wall portion 32a and extend in a direction intersecting the upper wall portion 32a. In the present embodiment, the front side wall portion 33a, the back side wall portion 33b, the right side wall portion 34a, and the left side wall portion 34b are provided so as to rise perpendicularly in the thickness direction (Z direction) of the flat plate portion 35a. The front side wall portion 33a and the back side wall portion 33b are spaced apart from each other in the Y direction. The right side wall portion 34a and the left side wall portion 34b are spaced apart from each other in the X direction. The upper wall portion 32a is arranged connected to the front side wall portion 33a, the back side wall portion 33b, the right side wall portion 34a, and the left side wall portion 34b. The upper wall portion 32a is arranged to be parallel to the flat plate portion 35a, spaced apart in the Z direction. The flat plate portion 35a is configured in a so-called flange shape, and is provided to extend outwardly with respect to the front side wall portion 33a, the back side wall portion 33b, the right side wall portion 34a, and the left side wall portion 34b in the X-Y plane, i.e., to extend to the side opposite to the side where the opening 36a is located.

A portion 39a at which the upper wall portion 32a and the right side wall portion 34a are connected is configured with a curved surface. Similarly, a portion 39b at which the upper wall portion 32a and the left side wall portion 34b are connected is configured with a curved surface. In the present embodiment, the portion 39a where the upper wall portion 32a and the right side wall portion 34a are connected and the portion 39b where the upper wall portion 32a and the left side wall portion 34b are connected each constitute a rounded surface (R surface) when the linear motion guide unit 10a is viewed from the front (in the Y direction). The cover member 31a covers the rail 11a and the sliding member 21a in the space 37a surrounded by the upper wall portion 32a, the front side wall portion 33a, the back side wall portion 33b, the right side wall portion 34a, and the left side wall portion 34b. This makes it easier for the cover member 31a itself to be deformed, thereby reducing the risk of the cover member 31a sagging or bulging in the state where a first fastener 41a or a second fastener 41b, described later, is open. Therefore, the risk of interference between the sliding member 21a and the cover member 31a can be reduced, and the smooth operation of the sliding member 21a can be more reliably ensured.

At least a portion of the cover member 31a has a structure made of a plurality of resin materials of different strengths stacked. Specifically, the cover member 31a is made entirely of urethane rubber, for example. Then, urethane tarpaulin, hot-melt sheet, or the like can be attached to a portion of the cover member 31a, the flat plate portion 35a, by gluing or welding, to thereby maintain high strength while ensuring appropriate flexibility in the flat plate portion 35a. In other words, the region where the flat plate portion 35a is located has a structure in which urethane rubber, urethane tarpaulin, and a hook and loop fastener 38a, which will be described later, are stacked. Thus, the risk of interference with the sliding member 21a can be reduced while the collapse of the shape can be suppressed in at least a portion of the cover member 31a, the flat plate portion 35a. As for the material for at least a portion of the cover member 31a, the region between a first left side element 43a and a second right side element 42b, which will be described later, may be composed of an elastic body other than urethane rubber.

The linear motion guide unit 10a includes shielding members 61a and 61b. The shielding members 61a and 61b each have a shape obtained by bending a plate-shaped member into an L shape and are provided so as to extend in the longitudinal direction. The shielding member 61a is attached to the rail side surface 14a and is arranged between the rail side surface 14a and a first opening region 46a of a first fastener 41a, described later, as viewed from the rail upper surface 12a side in a direction perpendicular to the longitudinal direction. The shielding member 61b is attached to the rail side surface 14b and is arranged between the rail side surface 14b and a second opening region 46b of a second fastener 41b, described later, as viewed from the rail upper surface 12a side in the direction perpendicular to the longitudinal direction.

The cover member 31a includes fasteners (a first fastener 41a and a second fastener 41b) each extending in the longitudinal direction (Y direction). The first fastener 41a and the second fastener 41b are each provided on the upper wall portion 32a. Specifically, the first fastener 41a is formed on a first tape member 47a, and the first tape member 47a with the first fastener 41a formed thereon constitutes a portion of the upper wall portion 32a of the cover member 31a. The second fastener 41b is formed on a second tape member 47b, and the second tape member 47b with the second fastener 41b formed thereon constitutes a portion of the upper wall portion 32a of the cover member 31a. The first fastener 41a and the second fastener 41b are arranged in parallel, spaced apart in the X direction. The first fastener 41a is provided on the right side with respect to the second fastener 41b. That is, in the present embodiment, two rows of fasteners are provided to extend in the longitudinal direction, spaced apart in the lateral direction.

The configuration of the first fastener 41a will now be described. The first fastener 41a includes a first right side element 42a, a first left side element 43a, a first front slider 44a, and a first rear slider 45a. The first right side element 42a extends along the longitudinal direction. The first left side element 43a is provided to extend in the longitudinal direction along the first right side element 42a. That is, the first right side element 42a and the first left side element 43a are disposed adjacent to each other in the X direction. The first left side element 43a is configured to be engageable with the first right side element 42a. The first front slider 44a is attached to the first right side element 42a and the first left side element 43a. The first front slider 44a is fixed to the sliding member 21a, specifically to the intermediate member 27a. The first rear slider 45a, similarly to the first front slider 44a, is attached to the first right side element 42a and the first left side element 43a. The first rear slider 45a is positioned apart from the first front slider 44a in the longitudinal direction (Y direction). The first rear slider 45a, similarly to the first front slider 44a, is fixed to the sliding member 21a, specifically to the intermediate member 27a.

During movement of the sliding member 21a, the first front slider 44a and the first rear slider 45a each disengage the first right side element 42a and the first left side element 43a from each other while the slider moves in a direction opposite to a side where the other slider is located, and engage the first right side element 42a and the first left side element 43a with each other while the slider moves in a direction toward the side where the other slider is located. A first opening region 46a is formed between the first front slider 44a and the first rear slider 45a in the longitudinal direction, which region is created when the first right side element 42a and the first left side element 43a are disengaged (see in particular FIGS. 8 and 9). In this first opening region 46a, first support members 57a and 58a, which will be described later, are arranged. It should be noted that the moving member 51a is arranged above this first opening region 46a, so that the first opening region 46a is not visible from the outside, in particular from the Z direction.

The configuration of the second fastener 41b will now be described. The second fastener 41b includes a second right side element 42b, a second left side element 43b, a second front slider 44b, and a second rear slider 45b. The second right side element 42b extends along the longitudinal direction. Specifically, the second fastener 41b is arranged such that the first left side element 43a of the first fastener 41a and the second right side element 42b of the second fastener 41b are spaced apart and adjacent to each other in the X direction. The second left side element 43b is provided to extend in the longitudinal direction along the second right side element 42b. That is, the second right side element 42b and the second left side element 43b are disposed adjacent to each other in the X direction. The second left side element 43b is configured to be engageable with the second right side element 42b. The second front slider 44b is attached to the second right side element 42b and the second left side element 43b. The second front slider 44b is fixed to the sliding member 21a, specifically to the intermediate member 27a. The second rear slider 45b, similarly to the second front slider 44b, is attached to the second right side element 42b and the second left side element 43b. The second rear slider 45b is positioned apart from the second front slider 44b in the longitudinal direction (Y direction). The second rear slider 45b, similarly to the second front slider 44b, is fixed to the sliding member 21a, specifically to the intermediate member 27a.

During movement of the sliding member 21a, the second front slider 44b and the second rear slider 45b each disengage the second right side element 42b and the second left side element 43b from each other while the slider moves in a direction opposite to a side where the other slider is located, and engage the second right side element 42b and the second left side element 43b with each other while the slider moves in a direction toward the side where the other slider is located. A second opening region 46b is formed between the second front slider 44b and the second rear slider 45b in the longitudinal direction, which region is created when the second right side element 42b and the second left side element 43b are disengaged (see in particular FIGS. 8 and 9). In this second opening region 46b, second support members 57b and 58b, which will be described later, are arranged. It should be noted that the moving member 51a is arranged above this second opening region 46b as well, so that the second opening region 46b is not visible from the outside, in particular from the Z direction.

The moving member 51a is plate-shaped. The moving member 51a has a rectangular outer shape as viewed in the Z direction. The moving member 51a is disposed outside the cover member 31a. Specifically, the moving member 51a is disposed above the upper wall portion 32a of the cover member 31a. The moving member 51a is arranged to straddle the two rows of the first fastener 41a and the second fastener 41b. The moving member 51a is provided with a plurality of attachment holes 52a. These attachment holes 52a are utilized for attaching a conveying member (not shown) which is conveyed together with the moving member 51a. The moving member 51a is provided with a plurality of connection holes 53a for connecting the member to the sliding member 21a, specifically to the intermediate member 27a included in the sliding member 21a. In the present embodiment, a total of four connection holes 53a are provided spaced apart from each other in the X and Y directions. The moving member 51a is also provided with a pair of receiving recesses 54a and 54b recessed inwardly from a lower surface located on the rail 11a side (see in particular FIG. 5). These receiving recesses 54a and 54b are shaped to receive the pair of positioning projections 29a and 29b, respectively, provided in the intermediate member 27a. The moving member 51a is connected and fixed to the intermediate member 27a included in the sliding member 21a through the connection holes 53a and the receiving recesses 54a and 54b, by utilizing the connecting members 56a, specifically first support members 57a, 58a and second support members 57b, 58b.

The connecting members 56a connect the sliding member 21a to the moving member 51a. The connecting members 56a include the first support members 57a, 58a and the second support members 57b, 58b. The first support members 57a and 58a each have a bolt shape extending in the Z direction. The first support members 57a and 58a are disposed apart from each other in the longitudinal direction. The first support members 57a and 58a are each disposed between the first front slider 44a and the first rear slider 45a in the longitudinal direction. Specifically, the first support members 57a and 58a are arranged in the first opening region 46a described above. In other words, the sliding member 21a covered by the cover member 31a and the moving member 51a disposed outside the cover member 31a can be connected by the first support members 57a and 58a via the first opening region 46a. The second support members 57b and 58b each have a bolt shape extending in the Z direction. The second support members 57b and 58b are disposed apart from each other in the longitudinal direction. The second support members 57b and 58b are each disposed between the second front slider 44b and the second rear slider 45b in the longitudinal direction. Specifically, the second support members 57b and 58b are arranged in the second opening region 46b described above. In other words, the sliding member 21a covered by the cover member 31a and the moving member 51a disposed outside the cover member 31a can be connected by the second support members 57b and 58b via the second opening region 46b. In the present embodiment, the moving member 51a is supported by the first support members 57a, 58a and the second support members 57b, 58b.

As viewed from the rail upper surface 12a side in the direction perpendicular to the longitudinal direction, the first opening region 46a created when the first right side element 42a and the first left side element 43a are separated from each other is placed in a position avoiding the rail 11a. In other words, the first opening region 46a is in a position that does not overlap the rail 11a as viewed in the Z direction. In the present embodiment, as viewed from the rail upper surface 12a side in the direction perpendicular to the longitudinal direction, the first fastener 41a is placed in a position avoiding the rail 11a. Similarly, as viewed from the rail upper surface 12a side in the direction perpendicular to the longitudinal direction, the second opening region 46b created when the second right side element 42b and the second left side element 43b are separated from each other is placed in a position avoiding the rail 11a. In other words, the second opening region 46b is in a position that does not overlap the rail 11a as viewed in the Z direction. In the present embodiment, as viewed from the rail upper surface 12a side in the direction perpendicular to the longitudinal direction, the second fastener 41b is placed in a position avoiding the rail 11a. More specifically, as viewed from the rail upper surface 12a side in the direction perpendicular to the longitudinal direction, the rail 11a is arranged between the first opening region 46a and the second opening region 46b in the X direction.

The specific configuration of the cover member 31a will now be described. The cover member 31a includes a hook and loop fastener 38a. Specifically, the hook and loop fastener 38a is provided on the flat plate portion 35a included in the wall. In the present embodiment, the hook and loop fastener 38a is disposed on one side in the thickness direction of the flat plate portion 35a. In this case, the hook and loop fastener 38a is disposed on the rail lower surface 12b side of the rail 11a. The hook and loop fastener 38a is disposed so as to surround the opening 36a. Specifically, the hook and loop fastener 38a is disposed over the entire area of the flat plate portion 35a. To attach the cover member 31a, the hook and loop fastener 38a of the cover member 31a is fitted to a hook and loop fastener (not shown) similarly provided at an installation location to thereby attach the cover member 31a. In this manner, the cover member 31a is fixed to a predetermined installation location. Such attachment using the hook and loop fastener 38a provides a freely detachable configuration.

According to the linear motion guide unit 10a of the present disclosure, the rail 11a and the sliding member 21a are accommodated in the space 37a formed by the upper wall portion 32a, the front side wall portion 33a, the back side wall portion 33b, the right side wall portion 34a, and the left side wall portion 34b, so that the cover member 31a covers the rail 11a and the sliding member 21a. During operation of the sliding member 21a, i.e., during a linear reciprocating motion of the sliding member 21a, the disengagement and engagement of the first right side element 42a and the first left side element 43a included in the first fastener 41a allow the sliding member 21a to slide while maintaining the state where the rail 11a and the sliding member 21a are covered by the cover member 31a. This improves the dustproof and waterproof properties during sliding of the sliding member 21a. Furthermore, the flat plate portion 35a is provided with the hook and loop fastener 38a, which eliminates the need for screws, adhesives, or the like for attaching the cover member 31a, and facilitates positioning. Since the fastening is done on a surface using the hook and loop fastener 38a, a gap is unlikely to occur, and a high level of sealing is maintained in the space 37a in which the rail 11a and the sliding member 21a are housed. Accordingly, the linear motion guide unit 10a described above is capable of improving the ease of attachment while ensuring a high level of sealing of the cover member 31a. It should be noted that the attachment using the hook and loop fastener 38a facilitates adjustment of its location, which also improves the convenience.

In the present embodiment, the hook and loop fastener 38a is arranged on one side in the thickness direction of the flat plate portion 35a. Thus, at the time of attaching the cover member 31a, the flat plate portion 35a can be utilized to properly attach the hook and loop fastener 38a to an installation location. This can further improve the ease of attachment.

In the present embodiment, the hook and loop fastener 38a is arranged to surround the opening 36a. This can further improve the sealing in the cover member 31a. Accordingly, a high level of sealing can be more reliably maintained.

Further, according to the linear motion guide unit 10a, as viewed from the rail upper surface 12a side in the direction perpendicular to the longitudinal direction, the first opening region 46a created when the first right side element 42a and the first left side element 43a are separated from each other is placed in a position avoiding the rail 11a, so even if foreign matter such as dust on the cover member 31a enters the inside of the cover member 31a when the first right side element 42a and the first left side element 43a are separated, the risk of the foreign matter reaching the rail 11a can be reduced. Consequently, the risk of the foreign matter adhering to the first raceway surfaces 15a and 15b can be reduced, and in the load-carrying races 18a and 18b composed of the first raceway surfaces 15a and 15b and the second raceway surfaces 17a and 17b, the obstruction of the smooth sliding of the sliding member 21a due to the foreign matter can be avoided. Therefore, according to such a linear motion guide unit 10a, smooth operation of the sliding member 21a can be ensured.

Furthermore, the linear motion guide unit 10a includes the second fastener 41b having the above configuration. Thus, since the second opening region 46b is placed in a position avoiding the rail 11a, even if foreign matter enters from the second opening region 46b, the risk of the foreign matter adhering to the first raceway surfaces 15a and 15b can be reduced, thereby ensuring smooth operation of the sliding member 21a. In addition, since the moving member 51a can be supported by both the first support members 57a, 58a and the second support members 57b, 58b, the load applied to the moving member 51a can be received in a distributed manner. Accordingly, the load bearing capacity can be improved.

In the present embodiment, the region between the first left side element 43a and the second right side element 42b is composed of an elastic body. This can suppress sagging or bulging of the region between the first left side element 43a and the second right side element 42b at the time of disengagement and engagement during the operation of the sliding member 21a, thereby reducing the risk of the cover member 31a interfering with the rail 11a and the sliding member 21a.

In the present embodiment, the shielding member 61a is attached to the rail side surface 14a and is arranged between the rail side surface 14a and the first opening region 46a of the first fastener 41a as viewed from the rail upper surface 12a side in the direction perpendicular to the longitudinal direction. In addition, the shielding member 61b is attached to the rail side surface 14b and is arranged between the rail side surface 14b and the second opening region 46b of the second fastener 41b as viewed from the rail upper surface 12a side in the direction perpendicular to the longitudinal direction. Thus, in the regions not covered by the cover member 31a, the shielding members 61a and 61b can reduce the risk of foreign matter entering from the sides of the rail side surfaces 14a and 14b. Accordingly, the smooth operation of the sliding member 21a can be more reliably ensured.

### Embodiment 2

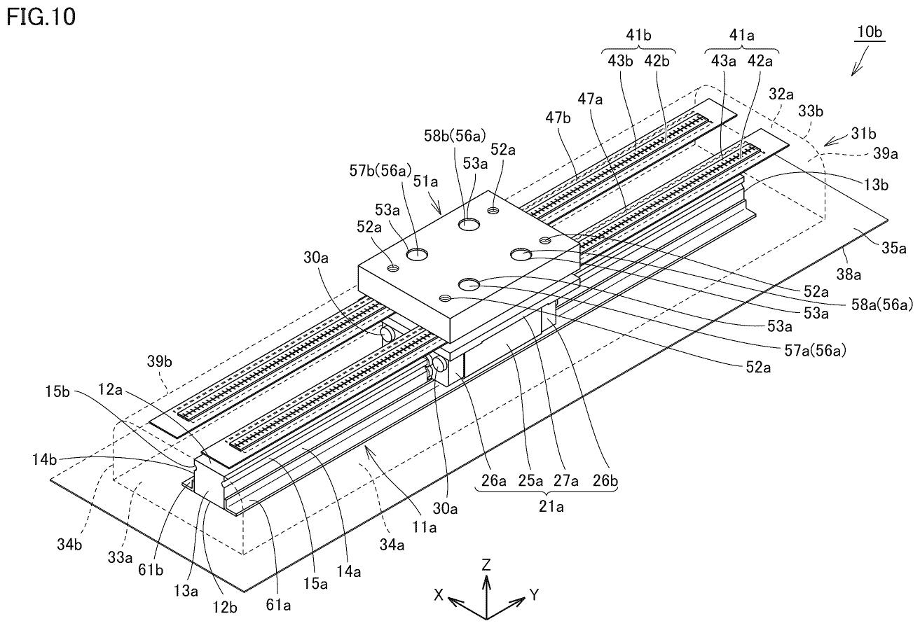

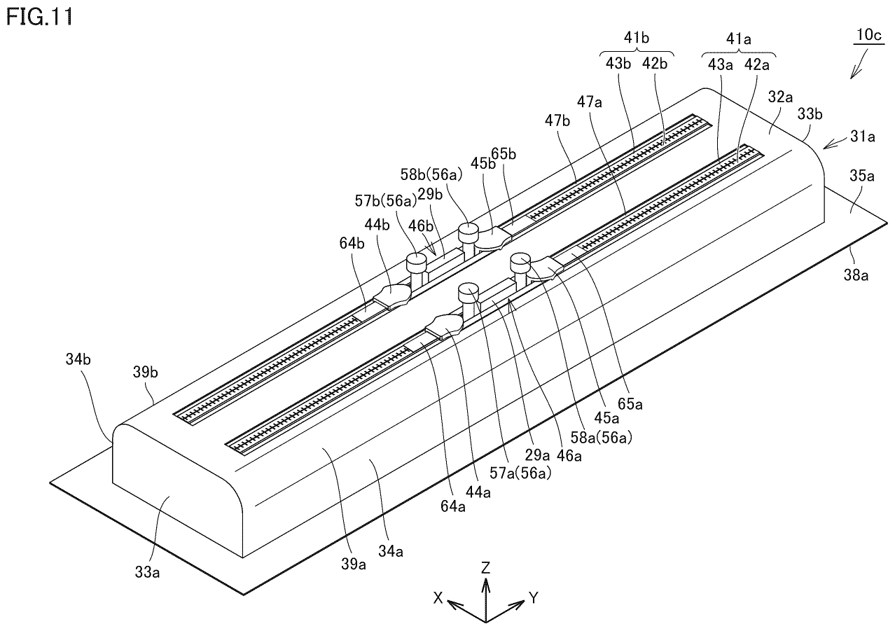

Another embodiment, Embodiment 2, will now be described. FIG. 10 is a schematic perspective view of a linear motion guide unit in Embodiment 2 of the present disclosure.

Referring to FIG. 10, in the linear motion guide unit 10b of Embodiment 2, an upper wall portion 32a, a front side wall portion 33a, a back side wall portion 33b, a right side wall portion 34a, and a left side wall portion 34b included in a cover member 31b make the inside visible from the outside. Specifically, the upper wall portion 32a, the front side wall portion 33a, the back side wall portion 33b, the right side wall portion 34a, and the left side wall portion 34b included in the cover member 31b are made of a transparent resin. This makes it easier to check the condition of the inside of the cover member 31b, and improves maintainability. It should be noted that a configuration making the inside visible is not necessarily provided in all of the upper wall portion 32a, the front side wall portion 33a, the back side wall portion 33b, the right side wall portion 34a, and the left side wall portion 34b described above. For example, a transparent configuration may be provided in the regions corresponding to the portions 39a and 39b in Embodiment 1 described above.

### Embodiment 3

Yet another embodiment, Embodiment 3, will now be described. FIG. 11 is a schematic perspective view of a portion of a linear motion guide unit in Embodiment 3 of the present disclosure. In FIG. 11, the illustration of a moving member is omitted.

Referring to FIG. 11, in the linear motion guide unit 10c of Embodiment 3, a first front slider 44a and a first rear slider 45a have seal members 64a and 65a that sweep an upper portion of the region where a first right side element 42a and a first left side element 43a are engaged. A second front slider 44b and a second rear slider 45b have seal members 64b and 65b that sweep an upper portion of the region where a second right side element 42b and a second left side element 43b are engaged. In this configuration, the seal members 64a and 65a move during the movement of the first front slider 44a and the first rear slider 45a, and the seal members 64b and 65b move during the movement of the second front slider 44b and the second rear slider 45b, so the seal members 64a, 65a, 64b, and 65b are capable of reducing the risk of foreign matter deposited on top of the cover member 31a entering the inside of the cover member 31a. Accordingly, the risk of foreign matter entering the load-carrying races 18a and 18b can be reduced, and the smooth operation of the sliding member 21a can be more reliably ensured.

### Embodiment 4

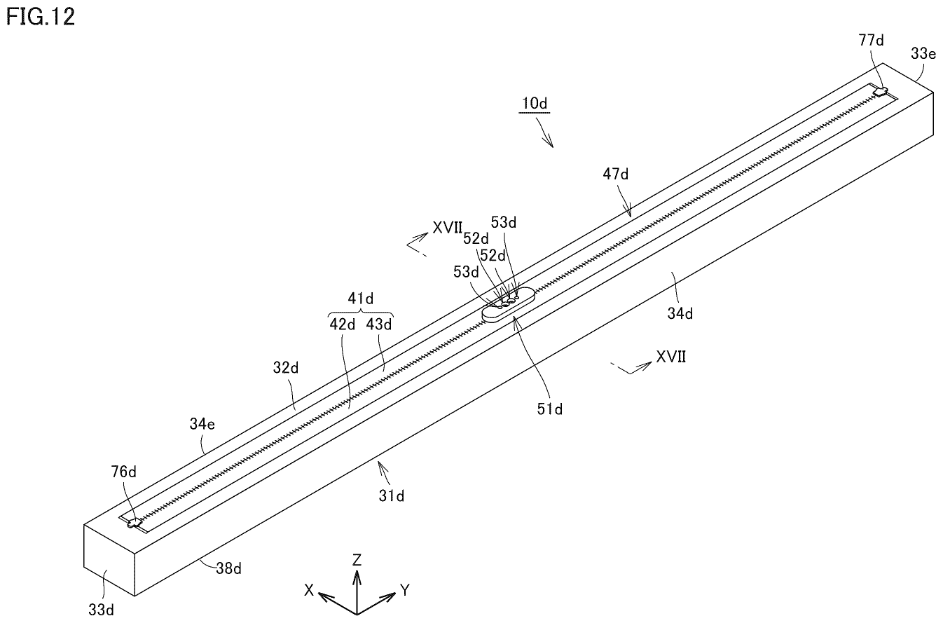

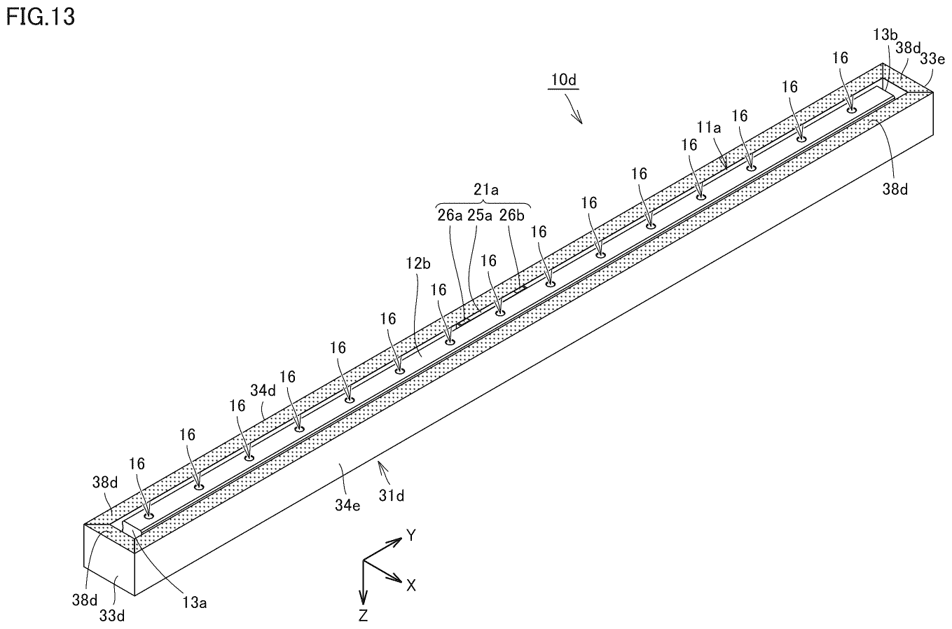

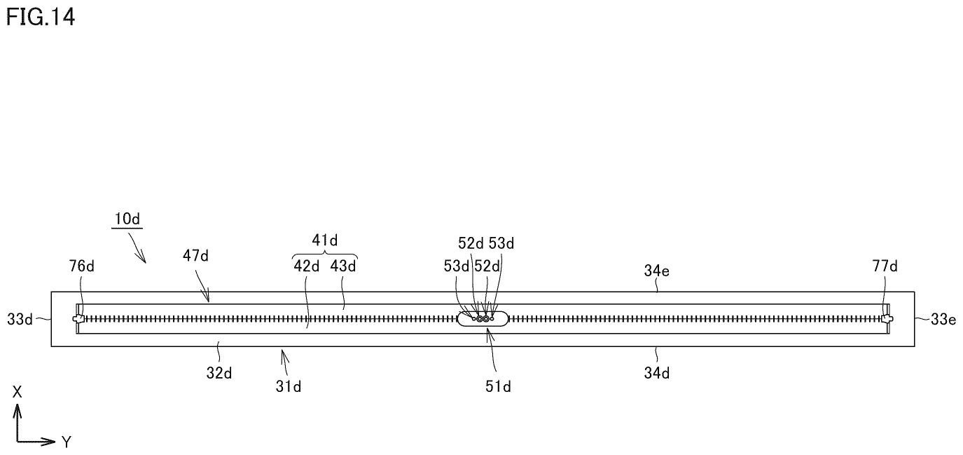

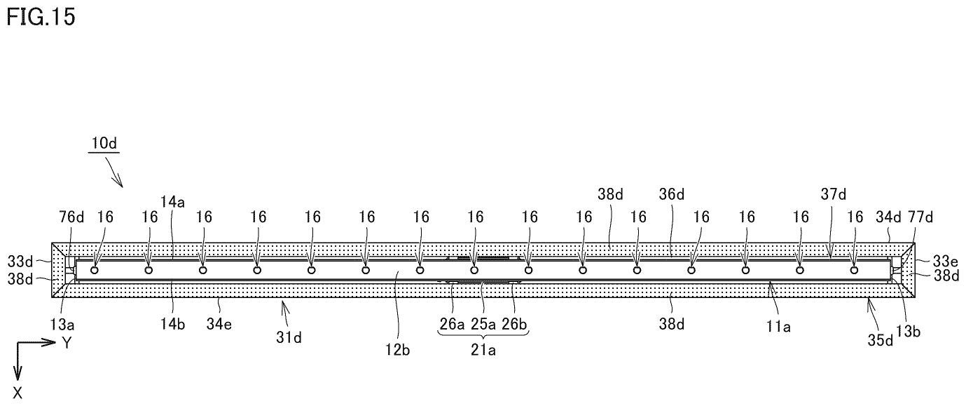

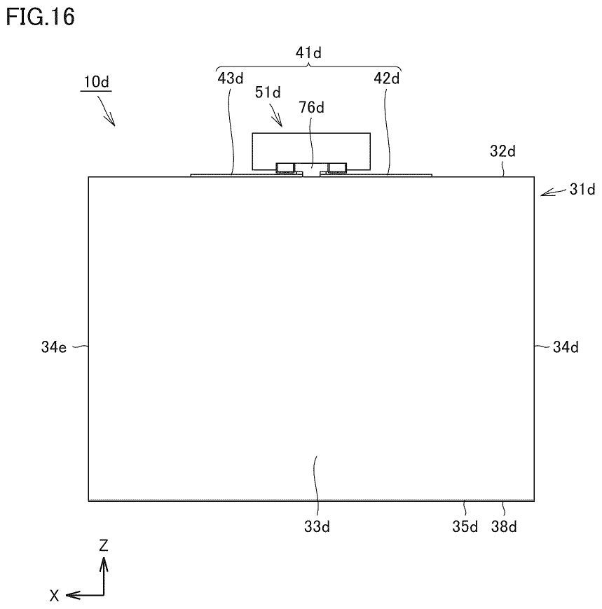

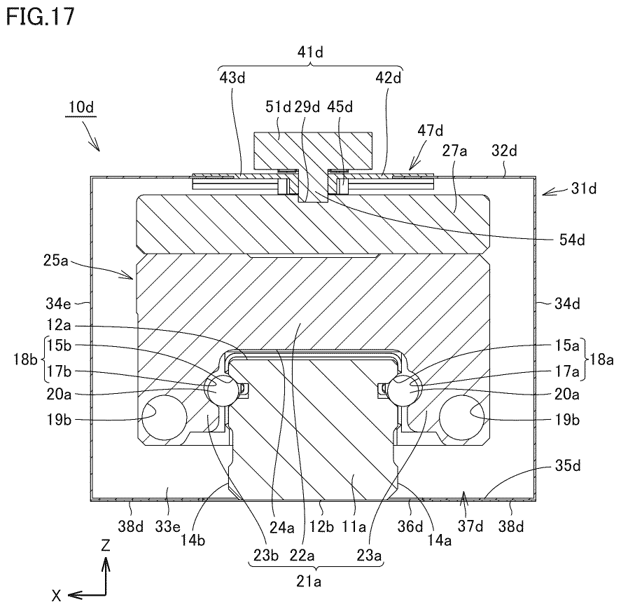

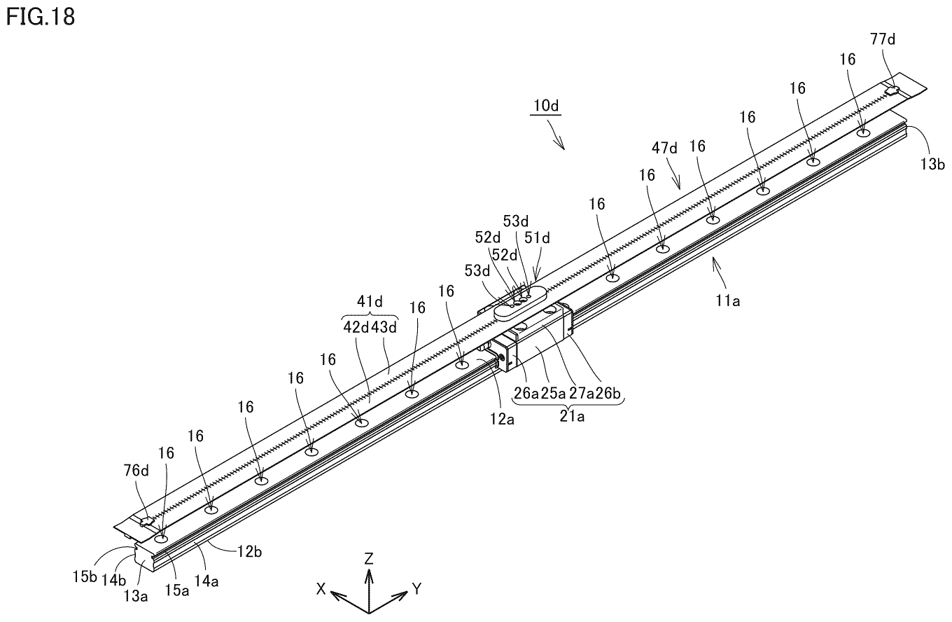

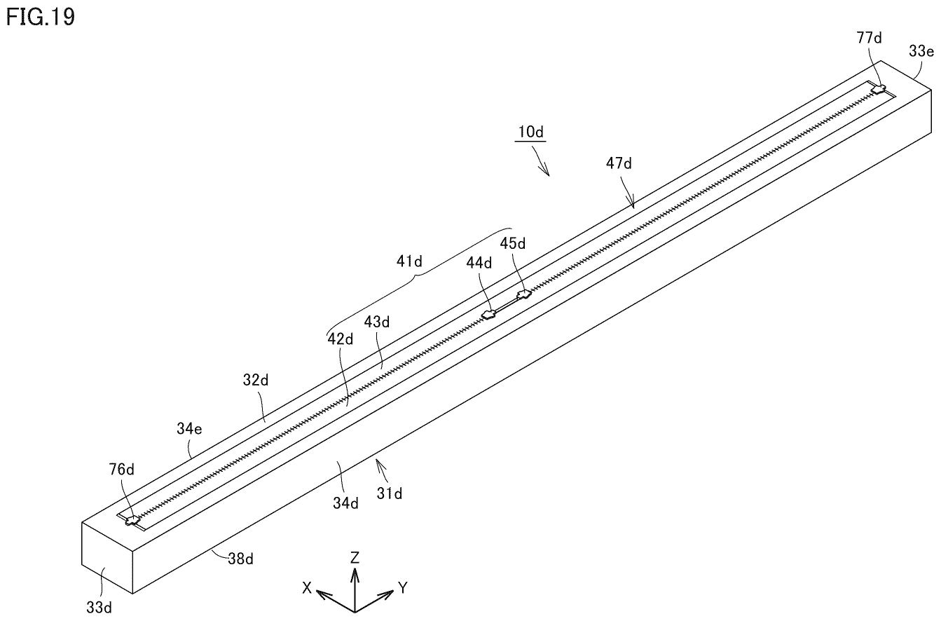

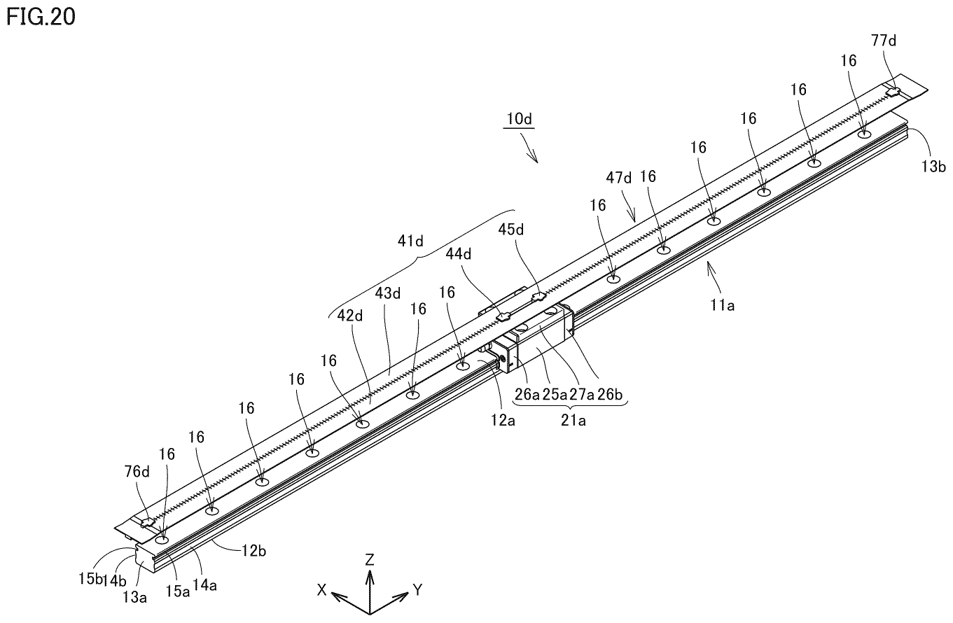

Yet another embodiment, Embodiment 4, will now be described. FIGS. 12 and 13 are schematic perspective views of a portion of a linear motion guide unit in Embodiment 4 of the present disclosure. FIGS. 12 and 13 are views in different angles. FIG. 14 is a schematic plan view of the linear motion guide unit shown in FIG. 12. FIG. 15 is a schematic bottom view of the linear motion guide unit shown in FIG. 12. FIG. 16 is a schematic front view of the linear motion guide unit shown in FIG. 12. FIG. 17 is a schematic cross-sectional view when cut in a cross section indicated by XVII-XVII in FIG. 2. FIG. 18 is a schematic perspective view of the linear motion guide unit shown in FIG. 12, with the illustration of a cover member partially omitted. FIG. 19 is a schematic perspective view of the linear motion guide unit shown in FIG. 12, with the illustration of a moving member omitted. FIG. 20 is a schematic perspective view of the linear motion guide unit shown in FIG. 12, with the illustration of the moving member and a part of the cover member omitted. The linear motion guide unit of Embodiment 4 differs from the linear motion guide unit of Embodiment 1 in the number of fasteners, the configuration of the flat plate portion, and others.

Referring to FIGS. 12 to 20, the linear motion guide unit 10d of Embodiment 4 includes a rail 11a, a sliding member 21a, balls 20a as the rolling elements, a cover member 31d, a moving member 51d, and connecting members (not shown). The rail 11a includes a rail upper surface 12a, a rail lower surface 12b, and rail side surfaces 14a and 14b, each extending in the longitudinal direction. The rail side surfaces 14a and 14b are provided with first raceway surfaces 15a and 15b. The basic shape of the rail 11a is equivalent to that of Embodiment 1, except for slight differences in the number of through holes 16, the shape of the first raceway surfaces 15a and 15b, and others. The sliding member 21a is relatively movably attached to the rail 11a. The sliding member 21a includes a sliding member lower surface 24a facing the rail upper surface 12a and second raceway surfaces 17a and 17b facing the first raceway surfaces 15a and 15b. The sliding member 21a includes a carriage 25a, a front end cap 26a, a rear end cap 26b, and an intermediate member 27a. The basic configuration of the sliding member 21a is also equivalent to that of Embodiment 1. The balls 20a roll on load-carrying races 18a and 18b composed of the first raceway surfaces 15a and 15b and the second raceway surfaces 17a and 17b. It should be noted that the intermediate member 27a included in the sliding member 21a is plate-shaped, and is provided with a receiving recess 29d for receiving a positioning projection 54d, described later, provided in the moving member 51d.

The cover member 31d covers the rail 11a and the sliding member 21a. The cover member 31d includes a fastener 41d extending in the longitudinal direction. The cover member 31d includes a flat plate portion 35d with an opening 36d at the center, a front side wall portion 33a, a back side wall portion 33e, a right side wall portion 34d, and a left side wall portion 34e provided so as to rise from the flat plate portion 35d, and an upper wall portion 32d connected to each of the front side wall portion 33a, the back side wall portion 33e, the right side wall portion 34d, and the left side wall portion 34e. The upper wall portion 32d has the fastener 41d arranged to extend in the longitudinal direction. The rail 11a and the sliding member 21a are accommodated in a space 37d formed in the cover member 31d. In the present embodiment, the flat plate portion 35d included in the cover member 31d has a shape formed by bending, so-called inwardly, one end in the Z direction of each side wall portion, i.e., the front side wall portion 33a, the back side wall portion 33e, the right side wall portion 34d, and the left side wall portion 34e. The cover member 31d has a rectangular parallelepiped shape with the opening 36d arranged at a portion corresponding to the lower side of the rail 11a.

The moving member 51d is plate-shaped. The moving member 51d has a rectangular outer shape longer in the longitudinal direction (Y direction) as viewed in the Z direction. Each end in the longitudinal direction of the moving member 51d has an outer shape with rounded corners as viewed in the Z direction. The moving member 51d is disposed outside the cover member 31d. Specifically, the moving member 51d is disposed above the upper wall portion 32d of the cover member 31d. The moving member 51a is arranged on the fastener 41d. The moving member 51d has a plurality, two in the present embodiment, of attachment holes 52d. These attachment holes 52d are utilized for attaching a conveying member (not shown) which is conveyed together with the moving member 51d. The moving member 51d moves together with the sliding member 21a. The moving member 51d is provided with a plurality of connection holes 53d for connecting the member to the sliding member 21a, specifically to the intermediate member 27a included in the sliding member 21a. In the present embodiment, a total of two connection holes 53d are provided spaced apart from each other in the Y direction. The moving member 51a is also provided with a positioning projection 54d projecting from a lower surface located on the rail 11a side. This positioning projection 54d is shaped to be received in the receiving recess 29d provided in the intermediate member 27a. The moving member 51a is connected and fixed to the intermediate member 27a included in the sliding member 21a through the connection holes 53a by utilizing the connecting members (not shown).

The fastener 41d, which is equivalent to the first fastener 41a or the second fastener 41b in Embodiment 1, includes a right side element 42d, a left side element 43d, a front slider 44d, and a rear slider 45d. The right side element 42d and the left side element 43d each extend in the longitudinal direction and are engageable with each other. The front slider 44d and the rear slider 45d are each attached to the right side element 42d and the left side element 43d and fixed to the sliding member 21a and the moving member 51d. During movement of the sliding member 21a and the moving member 51d, the front slider 44d and the rear slider 45d each disengage the right side element 42d and the left side element 43d from each other while the slider moves in a direction opposite to a side where the other slider is located, and engage the right side element 42d and the left side element 43d with each other while the slider moves in a direction toward the side where the other slider is located. The fastener 41d is formed on a tape member 47d, and the tape member 47d with the fastener 41d formed thereon constitutes a portion of the upper wall portion 32d of the cover member 31d. In the present embodiment, there is one row of fastener 41d, different from the case of Embodiment 1. The fastener 41d is disposed at the center in the X direction of the upper wall portion 32d as viewed in the Z direction.

It should be noted that in the present embodiment, the cover member 31d includes a first auxiliary slider 76d and a second auxiliary slider 77d. The first auxiliary slider 76d and the second auxiliary slider 77d are both attached to the right side element 42d and the left side element 43d. The first auxiliary slider 76d is arranged in front of the front slider 44d, i.e., on the side of the front side wall portion 33d. In the present embodiment, the slider is arranged at the front ends in the longitudinal direction of the right side element 42d and the left side element 43d. By moving the first auxiliary slider 76d in the direction of the arrow Y, the right side element 42d and the left side element 43d are separated. By moving the first auxiliary slider 76d in the direction opposite to the arrow Y, the right side element 42d and the left side element 43d are engaged. The second auxiliary slider 77d is arranged behind the rear slider 45d, i.e., on the side of the back side wall portion 33e. In the present embodiment, the slider is arranged at the back ends in the longitudinal direction of the right side element 42d and the left side element 43d. By moving the second auxiliary slider 77d in the direction opposite to the arrow Y, the right side element 42d and the left side element 43d are separated. By moving the second auxiliary slider 77d in the direction of the arrow Y, the right side element 42d and the left side element 43d are engaged. The fastener 41d can be opened and closed by utilizing the first auxiliary slider 76d and the second auxiliary slider 77d configured as described above. The first auxiliary slider 76d and the second auxiliary slider 77d are effectively utilized by making the fastener 41d normally in the closed state, and by opening and closing the fastener 41d at the time of cleaning the inside of the cover member 31d or other occasions for maintenance of the linear motion guide unit 10d.

Here, the flat plate portion 35d is provided with a hook and loop fastener 38d. The hook and loop fastener 38d is disposed on one side in the thickness direction of the flat plate portion 35d. In this case, the hook and loop fastener 38d is disposed on the rail lower surface side of the rail 11a. Further, the hook and loop fastener 38d is disposed so as to surround the opening 36d. That is, the hook and loop fastener 38d is disposed over the entire area of the flat plate portion 35d. To attach the cover member 31d, the hook and loop fastener 38d of the cover member 31d is fitted to a hook and loop fastener (not shown) similarly provided at an installation location to thereby attach the cover member 31d. In this manner, the cover member 31d is fixed to a predetermined installation location. Such attachment using the hook and loop fastener 38d provides a freely detachable configuration.

According to the linear motion guide unit 10d of the present disclosure, the rail 11a and the sliding member 21a are accommodated in the space 37d formed by the upper wall portion 32d, the front side wall portion 33d, the back side wall portion 33e, the right side wall portion 34d, and the left side wall portion 34e, so that the cover member 31d covers the rail 11a and the sliding member 21a. During operation of the sliding member 21a, i.e., during a linear reciprocating motion of the sliding member 21a, the disengagement and engagement of the right side element 42d and the left side element 43d included in the fastener 41d allow the sliding member 21a to slide while maintaining the state where the rail 11a and the sliding member 21a are covered by the cover member 31d. This improves the dustproof and waterproof properties during sliding of the sliding member 21a. Furthermore, the flat plate portion 35d is provided with the hook and loop fastener 38d, which eliminates the need for screws, adhesives, or the like for attaching the cover member 31d, and facilitates positioning. Since the fastening is done on a surface using the hook and loop fastener 38d, a gap is unlikely to occur, and a high level of sealing is maintained in the space 37d in which the rail 11a and the sliding member 21a are housed. Accordingly, the linear motion guide unit 10d described above is capable of improving the ease of attachment while ensuring a high level of sealing of the cover member 31d. It should be noted that the attachment using the hook and loop fastener 38d facilitates adjustment of its location, which also improves the convenience.

### Embodiment 5

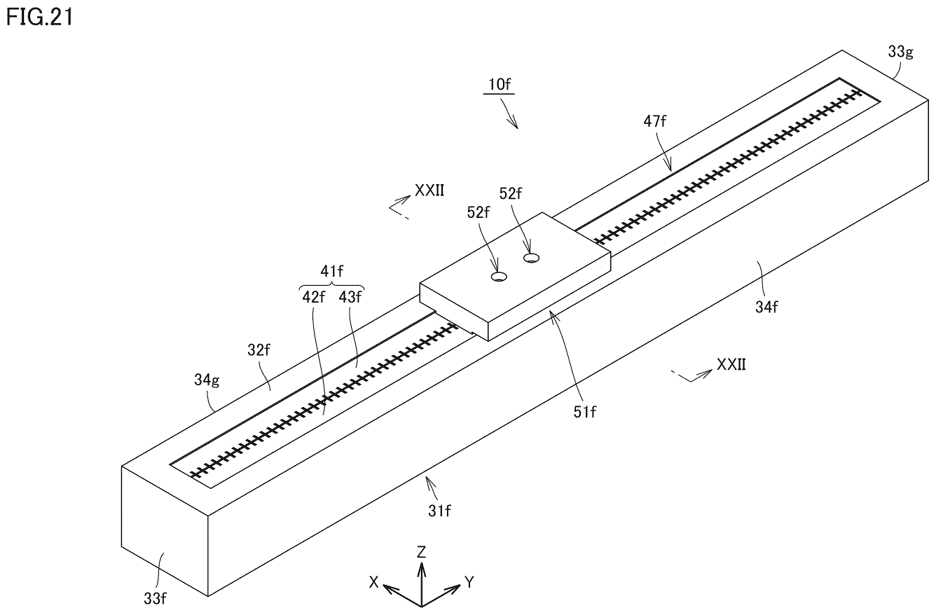

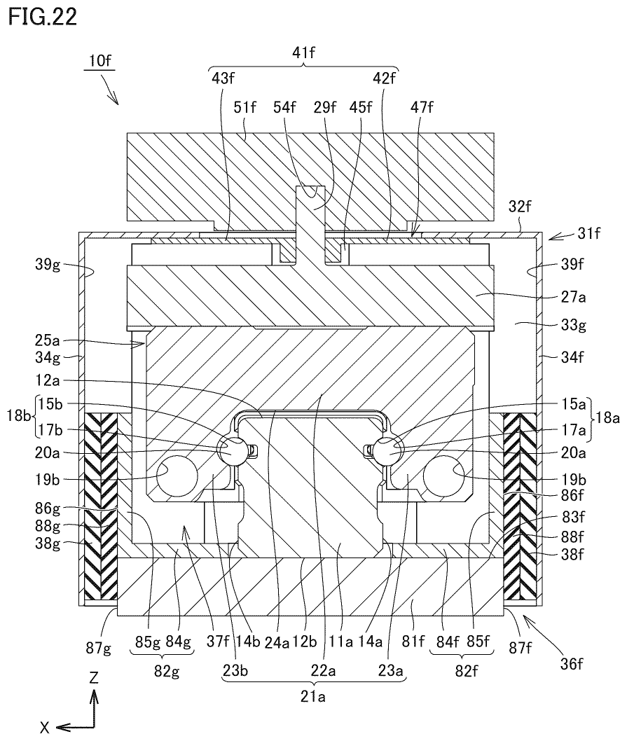

Yet another embodiment, Embodiment 5, will now be described. FIG. 21 is a schematic perspective view of a linear motion guide unit in Embodiment 5 of the present disclosure. FIG. 22 is a schematic cross-sectional view when cut in a cross section indicated by XXII-XXII in FIG. 21. The linear motion guide unit of Embodiment 5 differs from the linear motion guide unit of Embodiment 4 in the configuration of the cover member, and others.

Referring to FIGS. 21 and 22, the linear motion guide unit 10f of Embodiment 5 includes a rail 11a, a sliding member 21a, balls 20a as the rolling elements, a cover member 31f having a fastener 41f, a moving member 51f, and connecting members (not shown). The rail 11a includes a rail upper surface 12a, a rail lower surface 12b, and rail side surfaces 14a and 14b, each extending in the longitudinal direction. The rail side surfaces 14a and 14b are provided with first raceway surfaces 15a and 15b, respectively. The basic shape of the rail 11a is equivalent to that of Embodiment 4. The sliding member 21a is relatively movably attached to the rail 11a. The sliding member 21a includes a sliding member lower surface 24a facing the rail upper surface 12a and second raceway surfaces 17a and 17b facing the first raceway surfaces 15a and 15b. The sliding member 21a includes a base portion 22a and a pair of sleeve portions 23a and 23b. The sliding member 21a also includes a carriage 25a, a front end cap, a rear end cap, and an intermediate member 27a. The basic configuration of the sliding member 21a is also equivalent to that of Embodiment 1. The balls 20a roll on load-carrying races 18a and 18b, which are composed of the first raceway surfaces 15a and 15b and the second raceway surfaces 17a and 17b. It should be noted that the intermediate member 27a included in the sliding member 21a is plate-shaped, and is provided with a positioning projection 29f projecting on the moving member 51f side.

The moving member 51f is plate-shaped. The moving member 51f has a rectangular outer shape longer in the longitudinal direction (Y direction) as viewed in the Z direction. The moving member 51f is disposed outside the cover member 31f. Specifically, the moving member 51f is disposed above an upper wall portion 32f of the cover member 31f. The moving member 51f is arranged on the fastener 41f. The moving member 51f has a plurality, two in the present embodiment, of attachment holes 52f. These attachment holes 52f are utilized for attaching a conveying member (not shown) which is conveyed together with the moving member 51f. The moving member 51f moves together with the sliding member 21a. The moving member 51f is provided with a plurality of connection holes (not shown) for connecting the member to the sliding member 21a, specifically to the intermediate member 27a included in the sliding member 21a. The moving member 51f is also provided with a receiving recess 54f recessed from a lower surface located on the rail 11a side. This receiving recess 54f is shaped to receive the positioning projection 29f provided in the intermediate member 27a. The moving member 51f is connected and fixed to the intermediate member 27a included in the sliding member 21a through the connection holes by utilizing the connecting members (not shown). It should be noted that the first and second auxiliary sliders as in Embodiment 4 are not provided for the fastener 41f.

The cover member 31f covers the rail 11a and the sliding member 21a. The cover member 31f includes the fastener 41f extending in the longitudinal direction. The cover member 31f includes a front side wall portion 33f, a back side wall portion 33g, a right side wall portion 34f, and a left side wall portion 34g, and also includes an upper wall portion 32f connected to each of the front side wall portion 33f, the back side wall portion 33g, the right side wall portion 34f, and the left side wall portion 34g. The fastener 41f includes a right side element 42f, a left side element 43f, a front slider, and a rear slider. The fastener 41f is formed on a tape member 47f, and the tape member 47f with the fastener 41f formed thereon constitutes a portion of the upper wall portion 32f of the cover member 31f. In the present embodiment, the cover member 31f does not include a flat plate portion of Embodiment 4. The rail 11a and the sliding member 21a are accommodated in a space 37f provided in the cover member 31f. The cover member 31f has a rectangular parallelepiped shape with an opening 36f provided at a portion corresponding to the lower side of the rail 11a.

The cover member 31f also includes a base plate 81f having a rectangular shape as viewed in the thickness direction (Z direction), and a pair of mounting plates 82f and 82g attached to the base plate 81f. The base plate 81f extends in the longitudinal direction (Y direction) so as to block the opening 36f. The base plate 81f includes a side surface 87f located on one side in the X direction and a side surface 87g located on the other side in the X direction. The base plate 81f is configured to have a longitudinal length that is equal to a longitudinal length of the opening 36f of the cover member 31f. The rail 11a is attached to the base plate 81f. Specifically, the rail is attached by bolts, not shown, in such a manner that the rail lower surface 12b faces one side in the thickness direction of the base plate 81f, which in this case is a base plate upper surface 83f located on the space 37f side. In this case, a plurality of through holes 16 provided in the rail 11a are utilized. The rail 11a is attached to the base plate 81f so as to be centered in the lateral direction (X direction).

The mounting plates 82f and 82g each have a shape obtained by bending a thin plate-shaped member at a right angle, and extend in the longitudinal direction. The mounting plates 82f and 82g are also attached to the base plate 81f by bolts, not shown, or the like. In the present embodiment, the mounting plates 82f and 82g are attached so as to sandwich the rail 11a therebetween in the X direction. The mounting plate 82f includes a first portion 84f which is parallel to the X-Y plane, and a second portion 85f which is parallel to the Y-Z plane. The mounting plate 82f is attached such that the first portion 84f is in contact with the base plate upper surface 83f and the second portion 85f rises in the Z direction in the space 37f. Similarly, the mounting plate 82g includes a first portion 84g parallel to the X-Y plane and a second portion 85g parallel to the Y-Z plane, and is attached such that the first portion 84g is in contact with the base plate upper surface 83f and the second portion 85g rises in the Z direction in the space 37f. In the state where the mounting plates 82f and 82g are attached, one sleeve portion 23a of the sliding member 21a is arranged between the rail 11a and the second portion 85f, and the other sleeve portion 23b of the sliding member 21a is arranged between the rail 11a and the second portion 85g. The plates are also arranged such that a side surface 86f of the second portion 85f faces an inner wall surface 39f of the right side wall portion 34f located on the space 37f side, and that a side surface 86g of the second portion 85g faces an inner wall surface 39g of the left side wall portion 34g located on the space 37f side.

The side surface 86f of the second portion 85f has a hook and loop fastener 88f attached thereto. The side surface 86g of the second portion 85g has a hook and loop fastener 88g attached thereto. These hook and loop fasteners 88f and 88g are disposed over the entire areas in the Y and Z directions of the second portions 85f and 85g, respectively. The hook and loop fasteners 88f and 88g are arranged to extend halfway down the side surfaces 87f and 87g in the X direction of the base plate 81f.

Here, the cover member 31f has hook and loop fasteners 38f and 38g attached to the wall thereof, specifically to the right side wall portion 34f and the left side wall portion 34g. In the present embodiment, the hook and loop fastener 38f is attached to the inner wall surface 39f of the right side wall portion 34f, and the hook and loop fastener 38g is attached to the inner wall surface 39g of the left side wall portion 34g located on the space 37f side. In other words, unlike the cases of Embodiments 1 to 4, the hook and loop fasteners 38f and 38g are each provided parallel to the Y-Z plane. The hook and loop fasteners 38f and 38g are disposed over the entire areas in the Y direction of the inner wall surfaces 39f and 39g. The hook and loop fasteners 38f and 38g are arranged to extend from the ends of the inner wall surfaces 39f and 39g on the opening 36f side to halfway in the Z direction. The hook and loop fasteners 38f and 38g have their lengths in the Y direction and the Z direction equal to those of the hook and loop fasteners 88f and 88g, respectively.

The cover member 31f is attached to the base plate 81f and the mounting plates 82f, 82g by fitting the hook and loop fastener 88f to the hook and loop fastener 38f and the hook and loop fastener 88g to the hook and loop fastener 38g. That is, the cover member 31f is fixed to the base plate 81f and the mounting plates 82f, 82g by fitting the hook and loop fastener 38f and the hook and loop fastener 88f to each other and the hook and loop fastener 38g and the hook and loop fastener 88g to each other in the X direction. In this manner, the risk of foreign matter such as dust accumulating on the portions where the hook and loop fasteners 38f, 38g are disposed can be reduced. Accordingly, the risk of the foreign matter entering the cover member 31f can be reduced, and the smooth operation of the sliding member 21a can be more reliably ensured.

In this case, the hook and loop fastener 38f and the hook and loop fastener 38g can be fitted to the hook and loop fastener 88f and the hook and loop fastener 88g, respectively, to block the opening 36f. This can improve the sealing of the space 37f in the cover member 31f, thereby ensuring smooth sliding of the sliding member 21a.

### OTHER EMBODIMENTS

While balls are used as the rolling elements in the above embodiments, the rolling elements are not limited thereto; rollers may be used as the rolling elements.

Further, while one or two rows of fasteners are provided in the above embodiments, the configuration is not limited thereto; three or more rows of fasteners may be provided.

While the hook and loop fastener is provided over the entire area on one side in the thickness direction of the flat plate portion in the above embodiments, the configuration is not limited thereto; the hook and loop fastener may be provided at a portion on one side in the thickness direction of the flat plate portion.

It should be noted that in the above embodiments, at least one of the right side element and the left side element may include an oil-containing resin provided at the portion where the elements are engaged with each other. This can promote the smooth movement of the right side element and the left side element, and the smooth operation of the sliding member can be ensured.

It should be understood that the embodiments disclosed herein are illustrative and non-restrictive in every respect. The scope of the present invention is defined by the terms of the claims, and is intended to include any modifications within the scope and meaning equivalent to the terms of the claims.

### REFERENCE SIGNS LIST

10a, 10b, 10c, 10d, 10f: linear motion guide unit; 11a: rail; 12a: rail upper surface; 12b: rail lower surface; 13a: rail front surface; 13b: rail back surface; 14a, 14b: rail side surface; 15a, 15b: first raceway surface; 16: through hole; 17a, 17b: second raceway surface; 18a, 18b: load-carrying race; 19a, 19b: return passage; 20a: ball; 21a: sliding member; 22a: base portion; 23a, 23b: sleeve portion; 24a: sliding member lower surface; 25a: carriage; 26a: front end cap; 26b: rear end cap; 27a: intermediate member; 29a, 29b, 29f, 54d: positioning projection; 29d, 54a, 54b, 54f: receiving recess; 31a, 31b, 31d, 31f: cover member; 32a, 32d, 32f: upper wall portion; 33a, 33d, 33f: front side wall portion; 33b, 33e, 33g: back side wall portion; 34a, 34d, 34f: right side wall portion; 34b, 34e, 34g: left side wall portion; 35a, 35d: flat plate portion; 36a, 36d, 36f: opening; 37a, 37d, 37f: space; 38a, 38d, 38f, 38g, 88f, 88g: hook and loop fastener; 39a, 39b: portion; 39f, 39g: inner wall surface; 41a: fastener (first fastener); 41b: fastener (second fastener); 41d, 41f: fastener; 42a: right side element (first right side element); 42b: right side element (second right side element); 42d, 42f: right side element; 43a: left side element (first left side element); 43b: left side element (second left side element); 43d, 43f: left side element; 44a: front slider (first front slider); 44b: front slider (second front slider); 44d: front slider; 45a: rear slider (first rear slider); 45b: rear slider (second rear slider); 45d: rear slider; 46a: opening region (first opening region); 46b: opening region (second opening region); 47a: tape member (first tape member); 47b: tape member (second tape member); 47d, 47f: tape member; 51a, 51d, 51f: moving member; 52a, 52d, 52f: attachment hole; 53a, 53d: connection hole; 56a: connecting member; 57a, 58a: first support member; 57b, 58b: second support member; 61a, 61b: shielding member; 64a, 64b, 65a, 65b: seal member; 76d: first auxiliary slider; 77d: second auxiliary slider; 81f: base plate; 82f, 82g: mounting plate; 83f: base plate upper surface; 84f, 84g: first portion; 85f, 85g: second portion, and 86f, 86g, 87f, 87g: side surface.

1. A cover member including a longitudinally extending fastener and covering a mechanical element component, the cover member comprising:
a wall having the fastener arranged thereon and forming a space for accommodating the mechanical element component;
the fastener including
a right side element extending along the longitudinal direction,
a left side element extending in the longitudinal direction along the right side element and engageable with the right side element,
a front slider attached to the right side element and the left side element, and
a rear slider attached to the right side element and the left side element and spaced apart from the front slider in the longitudinal direction,
during movement of the front slider and the rear slider in the longitudinal direction, the front slider and the rear slider each disengaging the right side element and the left side element from each other while the slider moves in a direction opposite to a side where the other slider is located, and engaging the right side element and the left side element with each other while the slider moves in a direction toward the side where the other slider is located,
the wall having a hook and loop fastener provided thereon.

2. A linear motion guide unit comprising:
a rail including a rail upper surface and a rail side surface each extending in a longitudinal direction, the rail having a first raceway surface provided on the rail side surface;
a sliding member relatively movably attached to the rail, the sliding member including a sliding member lower surface facing the rail upper surface and a second raceway surface facing the first raceway surface;
a plurality of rolling elements rolling on a load-carrying race constituted by the first and second raceway surfaces;
a cover member covering the rail and the sliding member, the cover member including a fastener extending in the longitudinal direction;
a moving member arranged outside the cover member and moving together with the sliding member; and
a connecting member connecting the sliding member to the moving member;
the cover member including a wall, the wall having the fastener arranged thereon and forming a space for accommodating the rail and the sliding member,
the fastener including
a right side element extending along the longitudinal direction,
a left side element extending in the longitudinal direction along the right side element and engageable with the right side element,
a front slider attached to the right side element and the left side element and fixed to the sliding member and the moving member, and
a rear slider attached to the right side element and the left side element, spaced apart from the front slider in the longitudinal direction, and fixed to the sliding member and the moving member,
during movement of the sliding member and the moving member, the front slider and the rear slider each disengaging the right side element and the left side element from each other while the slider moves in a direction opposite to a side where the other slider is located, and engaging the right side element and the left side element with each other while the slider moves in a direction toward the side where the other slider is located,
the connecting member including a support member arranged between the front slider and the rear slider in the longitudinal direction and supporting the moving member,
the wall having a hook and loop fastener provided thereon.

3. The linear motion guide unit according to claim 2, wherein
the wall includes a flat plate portion, and
the hook and loop fastener is arranged on one side in a thickness direction of the flat plate portion.

4. The linear motion guide unit according to claim 2, wherein
the wall has an opening communicating with the space, and
the hook and loop fastener is arranged to surround the opening.

5. The linear motion guide unit according to claim 2, wherein
the wall includes
an upper wall portion on which the fastener is arranged, and
a side wall portion that extends intersecting the upper wall portion, and
the hook and loop fastener is attached to the side wall portion.

6. The linear motion guide unit according to claim 2, wherein at least a portion of the cover member includes a structure made of a plurality of resin materials of different strengths stacked.

7. The linear motion guide unit according to claim 2, wherein at least a portion of the cover member makes an inside visible from an outside.

8. The linear motion guide unit according to claim 2, wherein at least one of the front slider and the rear slider has a seal member operative to sweep an upper portion of a region in which the right side element and the left side element are engaged.

9. The linear motion guide unit according to claim 2, wherein
the wall includes
an upper wall portion on which the fastener is arranged, and
a side wall portion that extends intersecting the upper wall portion, and
a portion where the upper wall portion and the side wall portion are connected is configured with a curved surface.

10. The linear motion guide unit according to claim 2, wherein at least one of the right side element and the left side element includes an oil-containing resin provided at a portion where the elements are engaged with each other.

11. The linear motion guide unit according to claim 3, wherein
the wall has an opening communicating with the space, and
the hook and loop fastener is arranged to surround the opening.

12. The linear motion guide unit according to claim 3, wherein
the wall includes
an upper wall portion on which the fastener is arranged, and
a side wall portion that extends intersecting the upper wall portion, and
the hook and loop fastener is attached to the side wall portion.

13. The linear motion guide unit according to claim 3, wherein at least a portion of the cover member includes a structure made of a plurality of resin materials of different strengths stacked.

14. The linear motion guide unit according to claim 3, wherein at least a portion of the cover member makes an inside visible from an outside.

15. The linear motion guide unit according to claim 3, wherein at least one of the front slider and the rear slider has a seal member operative to sweep an upper portion of a region in which the right side element and the left side element are engaged.

16. The linear motion guide unit according to claim 3, wherein
the wall includes
an upper wall portion on which the fastener is arranged, and
a side wall portion that extends intersecting the upper wall portion, and
a portion where the upper wall portion and the side wall portion are connected is configured with a curved surface.

17. The linear motion guide unit according to claim 3, wherein at least one of the right side element and the left side element includes an oil-containing resin provided at a portion where the elements are engaged with each other.
